(19) United States
(12) Patent Application Publication
(10) Pub. No.: US 2022/0176331 A1
(43) Pub. Date: Jun. 9, 2022

(54) MACHINE FOR DISPENSING A CONTROLLED QUANTITY OF A COSMETIC COMPOSITION

(71) Applicant: L'OREAL, Paris (FR)

(72) Inventor: Vincent MARCHAL, Aulnay-sous-Bois (FR)

(73) Assignee: L'OREAL, Paris (FR)

(21) Appl. No.: 17/441,490

(22) PCT Filed: Mar. 24, 2020
(86) PCT No.: PCT/EP2020/058123

§ 371 Date: Sep. 21, 2021

(30) Foreign Application Priority Data
Mar. 25, 2019 (FR) FR1903069

(51) Int. Cl. B01F 35/88; A45D 40/24; A45D 44/00; B01F 35/42; B01F 33/84

(52) U.S. Cl. CPC B01F 35/881; A45D 40/24; A45D 2034/005; B01F 35/42; B01F 33/84; A45D 44/005

(57) ABSTRACT

Machine for dispensing a controlled quantity of a cosmetic composition The present application relates to a machine for dispensing a determined quantity of a cosmetic product into a receptacle from a reservoir, the machine comprising, on the one hand, a body configured such as to receive at least one cartridge forming a reservoir of the cosmetic product to be dispensed and, on the other hand, a dispensing zone configured such as to receive a receptacle capable of containing said quantity of cosmetic product to be dispensed, the machine being characterized in that the reception zone comprises an attachment member capable of interacting with a complementary part of the receptacle in such a manner as to effect the suspension thereof in the reception zone, the attachment member being mounted on a load cell.

The present invention relates to a machine for dispensing a controlled quantity of at least one cosmetic product into a receptacle from a reservoir of larger capacity, the machine comprising a dispensing zone configured such as to receive the receptacle capable of containing said quantity of cosmetic product to be dispensed.

“Cosmetic product” is understood to mean any product as defined in Regulation (EC) No 1223/2009 of the European Parliament and of the Council of Nov. 30, 2009 on cosmetic products. Thus, a cosmetic product is generally defined as being a substance or a mixture designed to be brought into contact with surface parts of the human body (epidermis, body hair and head hair, nails, lips, and external genitalia) or with the teeth and the oral mucous membranes in order, exclusively or mainly, to cleanse them, to fragrance them, to modify their appearance, to protect them, to keep them in good condition, or to correct body odors.

The cosmetics industry always aims to improve consumer-experience and to offer products and compositions that are ever-more adapted to consumers' needs and their specific characteristics. This trend is generally termed “customization”.

It is thus, for example, known to recommend foundations adapted on the basis of one or more characteristics of a user's skin (see, for example, documents U.S. Pat. Nos. 5,478,238 and 9,519,927). The treatment or cosmetic product designed in accordance with the users' specific characteristics may be an already-formulated finished product selected from a catalog or database, or a customized product of which the composition itself has been determined on the basis of the individual characteristics obtained (for example, “Le Teint Particulier”® offered by LANCÔME®).

It is also known to offer customized hair products of which the composition is determined on the basis of different properties of the user's hair (for example, WO2004/002300A2).

The product may then be purchased in the conventional way or ordered by the individual in question. In the case of a “custom-made” product, said product may be manufactured directly at the point of sale (store or salon, for example) using a device capable of dispensing components in accordance with the custom-made composition determined beforehand.

Such devices are, for example, described in documents US2017151538A1 in the case of a foundation and EP0443741, U.S. Pat. No. 9,316,580B in the case of hair-coloring products.

In general, such machines comprise a body configured such as to receive a plurality of cartridges of different cosmetic products made from ingredients suitable for being combined in order to form a final cosmetic composition. The machine may thus comprise one or more cartridges of one or more cosmetic bases (presented, for example, in the form of a cream) and/or one or more cartridges of active cosmetic products (dyes, pigments, active care products, and the like) designed to be added to one of the cosmetic bases in order to form the final composition in accordance with the consumer's wishes.

The machines also comprise a dispensing zone configured such as to receive a receptacle capable of containing said cosmetic composition. In the case of products of care-cream or foundation type, the receptacle may conventionally be a bottle or jar. In the case of a hair-dyeing product, the receptacle may, notably, be a mixing bowl.

Electromechanical systems of the pump or piston type take up a quantity of cosmetic product and move it from the desired cartridge to the dispensing zone where the product may be transferred into the receptacle via a dispensing nozzle arranged opposite an opening of said receptacle.

In the case of a custom-made cosmetic product of which the composition is defined to suit the user and is manufactured on demand, either in-store or in the user's home, it is important to be able precisely to control the quantity of each ingredient dispensed into the receptacle, even if the machine is equipped with electromechanical systems with controlled movement of the metering-pump or metering-piston type. To that end, the reception zone is generally equipped with scales comprising a pan on which the receptacle is placed.

In the course of use, the pan of the scales may accumulate dust or even become fouled with product, which may result in inaccurate measurements. This requires a high level of maintenance and inspection, and also frequent cleaning.

Furthermore, such machines that use a support pan in the reception zone generally have to be equipped with a mechanical system allowing, once the receptacle has been placed in the reception zone, the dispensing nozzle to be brought close to the opening of said receptacle, and then to be distanced from the nozzle once more in order to clear said zone and to allow the withdrawal of the receptacle. The mechanical system may lower the nozzle toward the opening of the receptacle or, alternately, the nozzle may be fixed and the pan may be moved upward in order to raise the receptacle back up toward the nozzle. The presence of such a mechanical system is a source of potential breakdowns and also requires a high level of maintenance and inspection.

The use of a support pan may likewise give rise to problems in terms of positioning the receptacle relative to the dispensing nozzle, incorrect positioning of the receptacle, and in particular incorrect positioning of the opening thereof, which can cause product to run outside the latter and is clearly undesirable.

There is thus a need for a machine for dispensing cosmetic product that has a reception zone that ensures easy, reliable positioning of the receptacle and a reduced level of maintenance.

The present invention aims to respond to all or some of these problems and to that end proposes a machine for dispensing a determined quantity of at least one cosmetic product into a receptacle from a reservoir, the machine comprising, on the one hand, a body configured such as to receive at least one cartridge forming a reservoir of the cosmetic product to be dispensed and, on the other hand, a dispensing zone configured such as to receive the receptacle capable of containing said quantity of cosmetic product to be dispensed, the machine being characterized in that the reception zone comprises an attachment member capable of interacting with a complementary part of the receptacle in such a manner as to effect the suspension thereof in the reception zone, the attachment member being mounted on a load cell.

Thus, by providing an attachment member that allows the receptacle to be suspended and that is equipped with a load cell, it is possible to monitor the filling of said receptacle, thereby overcoming any likelihood of error due to a support pan.

Moreover, the load cell is mounted to be fixed relative to the body of the machine and may be chosen to offer a reduced range of elongation under the effect of the maximum weight that might be achieved by the filled bottle. This range of elongation will typically be less than one centimeter, preferably less than 2 mm. Such a range of elongation obviates a relative movement of a dispensing nozzle with regard to the receptacle when dispensing takes place.

The load cell is preferably electronic so that it can be easily connected to a control device capable of managing pump- or piston-type electromechanical systems taking up and moving the cosmetic product to be dispensed.

Advantageously, the attachment member is capable of engaging with a peripheral part of the receptacle. Preferably, the attachment member is capable of engaging with the receptacle close to an opening of said receptacle, notably with a part of a neck of said receptacle.

Preferably, the attachment member has an least partially annular, preferably annular, form that forms a ring, a central opening of the attachment member opening out over the opening of the receptacle. Thus, a dispensing nozzle may be positioned above the central opening and the product may thus be transferred inside the receptacle directly via the attachment member.

According to a preferred embodiment, the attachment member comprises at least one magnet capable of interacting with a complementary magnet of a part of the receptacle. Thus, the positioning of the receptacle in the reception zone is facilitated, since it suffices to bring the receptacle closer to the attachment member in order for the magnetic retention force to assist in positioning and centering, without the need for more or less complex locking/unlocking manipulation.

Alternately, the attachment member may effect mechanical retention notably by means of a screwing system or a bayonet system. Such a system is, however, less preferred because it requires a locking/unlocking operation. What is more, incorrect positioning could lead to an operator wanting to use force, which would risk damaging the attachment system on the machine and/or the bottle. The attachment member may also be in the form of a fork capable of engaging with a corresponding rim of the receptacle.

Advantageously, the attachment member comprises a plurality of, preferably three, magnets, distributed such as to be spaced from one another and preferably regularly spaced about the attachment member, notably at 120°. Thus, when the magnets are not exactly opposite the complementary magnets, a slight rotation of the receptacle will allow the magnetic forces of the attachment member to easily “attach”. Moreover, as the magnets are independent, a slight rotation of the receptacle also makes it possible to place the magnetic fields out of alignment and to easily release the receptacle after filling. Preferably, the magnets are chosen and positioned such that a slight rotation of the receptacle of about 15 degrees makes it possible to release said receptacle from the field of magnetic attraction.

The present invention also relates to a receptacle for a machine according to the invention, said receptacle comprising a body defining an interior space for reception of the cosmetic product and of which a free edge delimits an opening located opposite a bottom. The receptacle is characterized in that it comprises an attachment part complementing the attachment member of the machine according to the present application.

Preferably, the complementary attachment part is removable and capable of being attached temporarily to the receptacle. It may, notably, be a ring mounted on said receptacle, notably, in the case of a bottle, on a threaded neck normally used to mount a closure cap thereon. It is thus possible to use a standard bottle, to which the attachment ring will be fitted for the purpose of filling the bottle in the machine. Once the bottle has been filled, the attachment ring is removed and may be replaced by a cap. This is particularly advantageous in the case of magnetized attachment systems, which are relatively expensive, as it may be difficult for each individual bottle to be equipped with magnets owing to the likelihood of increasing the cost of each bottle.

According to another embodiment, the complementary attachment member is in the form of an ‘over-bottle’ or support basket, inside which the receptacle is temporarily arranged with a view to its filling by the machine.

Alternately, the complementary attachment member may obviously be integrated with the receptacle or else produced as a single component therewith. This may, in particular, be the case of bayonet-type or screwed mechanical attachment systems. The attachment system of the machine may notably be configured such as to have an internal screw thread that can be fitted directly to a threaded neck of the receptacle.

According to the preferred embodiment for the machine, the complementary attachment part of the receptacle comprises at least one magnet, preferably a plurality of magnets, for example three, distributed in a spaced manner and preferably regularly spaced about the complementary attachment part, notably at 120°.

The present invention further relates to a system for dispensing a determined quantity of a cosmetic product into a receptacle from a reservoir, said system comprising a machine according to the present application and at least one, preferably a plurality of, receptacles according to the present application.

The invention may be better understood on reading the following description, accompanied by non-limiting implementation examples thereof, with reference to the appended drawings, in which:

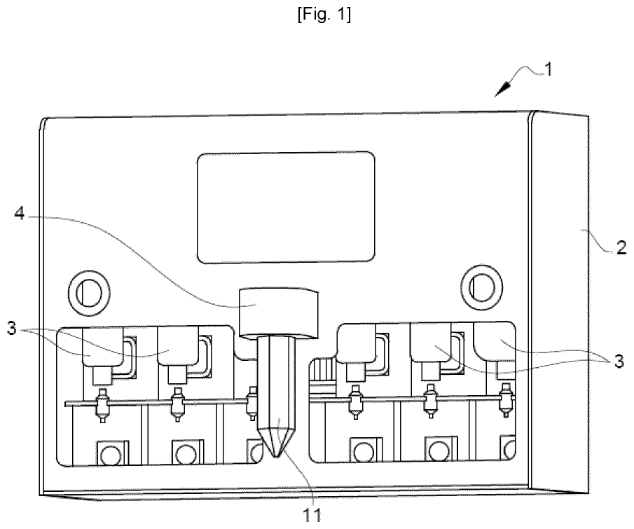

FIG. 1 is a schematic overall representation of a dispensing machine according to the invention,

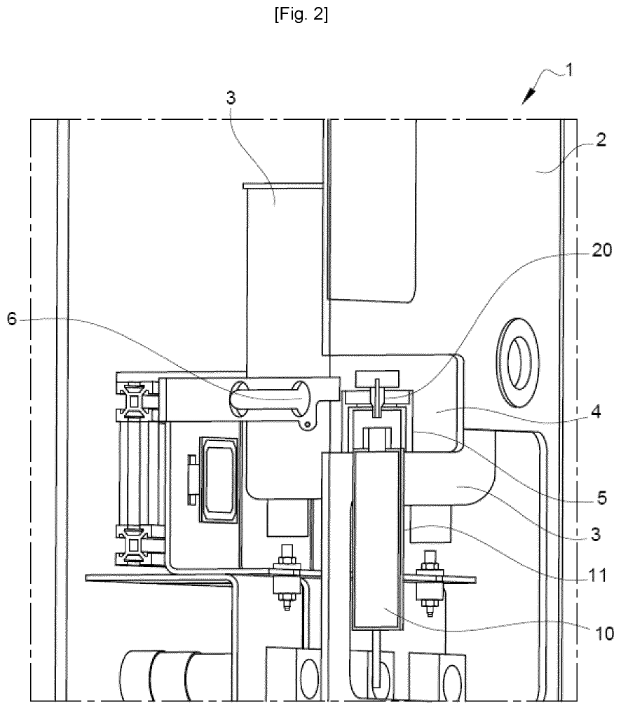

FIG. 2 is a schematic representation in transverse section of the machine of FIG. 1 in the region of its zone for reception of the receptacle,

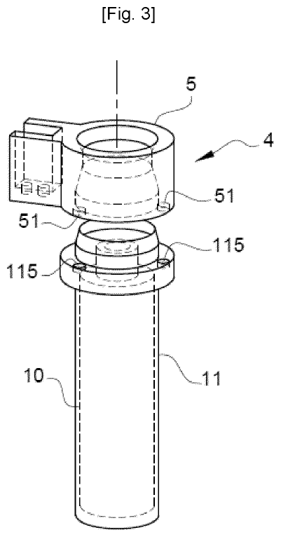

FIG. 3 is an isolated schematic representation of the system for suspended attachment of the receptacle in the machine of FIGS. 1 and 2.

FIG. 1 shows a machine 1 for manufacturing a custom-made cosmetic composition.

To that end, the machine has a body 2 housing an array of reservoirs 3 of cosmetic products.

In particular, the reservoirs 3 are removable cartridges that can be replaced, notably when a cartridge is empty, by a cartridge of the same product or of a different product. The cartridges may, for example, be in the form of a cartridge with a rigid body or that of flexible sachets.

The cosmetic products contained in the reservoirs 3 are designed to be combined together in such a manner as to form a final cosmetic composition.

To that end, the reservoirs 3 are each associated with one or more systems capable of taking up a determined quantity of cosmetic product in said reservoir 3 and of taking it to a dispensing zone 4 of the machine 1 where said quantity of cosmetic product can be transferred inside a receptacle 10 via a corresponding dispensing nozzle 20.

Among the take-up and dispensing systems that may be envisaged, it is possible to cite systems with pumps, notably peristaltic pumps, and also piston or syringe systems.

Also known is a system in which the reservoirs are carried by a carousel capable of bringing each reservoir to the reception zone, where a common piston is able to eject a desired quantity of cosmetic product into the receptacle located below a nozzle carried by said reservoir.

Such systems are not a subject of the present application and a person skilled in the art is free to select the appropriate transfer system.

Moreover, although more particularly designed for multi-product machines, the present application may apply to the dispensing of a single product contained, notably, in bulk form in a large-capacity reservoir, of which a consumer wishes to purchase only a small quantity in a reusable jar.

As indicated previously, the dispensing zone 4 is designed to receive a receptacle 10, notably a bottle or a jar, into which the one or more cosmetic products contained in the reservoirs are to be dispensed in controlled quantities.

To that end, and in accordance with the present application, the reception zone 4 comprises an attachment member 5 capable of interacting with a complementary part 11 of the receptacle 10 in such a manner as to effect the suspension thereof in said reception zone 4. The attachment member 5 is in the form of a ring having a central opening configured such as to arrive opposite an opening of the receptacle 10.

The attachment member 5 is, further, mounted on a load cell 6, notably an electronic load cell that allows monitoring of the mass of product transferred into the receptacle 10.

The load cell is connected to a device for controlling the machine 1 which is capable of managing the electromechanical systems that take up and move the cosmetic product to be dispensed. The control device is, notably, configured such as to halt dispensing of the cosmetic product when the load cell flags up a predetermined weight. Advantageously, the control device is capable of slowing and/or adapting the dispensing flow rate of the product upon nearing the target weight.

The complementary part 11 of the receptacle 10 with which the attachment member 5 engages is in the form of a removable over-bottle inside which the receptacle 10 to be filled with cosmetic product is inserted prior to placing thereof in the reception zone 4. After filling by the machine, the receptacle 10 is withdrawn from the over-bottle and may be replaced by another receptacle 10.

The over-bottle has a body that at least partially surrounds the receptacle 10 and of which a free edge delimits an upper opening coinciding with an upper opening of the receptacle 10 to be filled.

According to the embodiment shown, the free edge carries a plurality of magnets of a polarity that complements those of corresponding magnets carried by the attachment member 5 of the machine 1.

The magnets of the attachment member 5 and of the complementary attachment part are 3 in number, spaced from one another and distributed at 120° about said attachment member and the complementary attachment part.

The receptacle 10 is thus suspended from the attachment member 5 by magnetic retention. The magnets allow simple positioning without complex mechanical manipulation of the receptacle. After filling, the receptacle may likewise be easily withdrawn by simple rotation of the over-bottle, which makes it possible to place the magnets out of alignment and to thus release them from their magnetic attraction forces.

1. A machine for dispensing a determined quantity of a cosmetic product into a receptacle from a reservoir, the machine comprising, on the one hand, a body configured such as to receive at least one cartridge forming a reservoir of the cosmetic product to be dispensed and, on the other hand, a dispensing zone configured such as to receive a receptacle capable of containing said quantity of cosmetic product to be dispensed, the machine being characterized in that the reception zone comprises an attachment member capable of interacting with a complementary part of the receptacle in such a manner as to effect the suspension thereof in the reception zone, the attachment member being mounted on a load cell.

2. The machine as claimed in claim 1, wherein the attachment member is capable of engaging with a peripheral part of the receptacle.

3. The machine as claimed in claim 1, wherein the attachment member is capable of engaging with the receptacle close to an opening of said receptacle, notably with a part of a neck of said receptacle.

4. The machine as claimed in claim 1, wherein the attachment member has an at least partially annular, preferably annular, form, a central opening of the attachment member opening out over the opening of the receptacle.

5. The machine as claimed in claim 1, wherein the attachment member comprises at least one magnet capable of interacting with a complementary magnet of a part of the receptacle.

6. The machine as claimed in claim 5, wherein the attachment member comprises a plurality of, preferably three, magnets, distributed independently and preferably regularly about the attachment member, notably at 120°.

7. A receptacle for the dispensing machine as claimed in claim 1, said receptacle comprising a body defining an interior space for reception of the cosmetic product and of which a free edge delimits an opening located opposite a bottom, wherein the receptacle comprises an attachment part complementing the attachment member.

8. The receptacle as claimed in claim 7, wherein the complementary attachment part is removable and capable of being attached temporarily to the receptacle.

9. The receptacle as claimed in claim 8, wherein the complementary attachment part is in the form of a ring capable of being attached to the receptacle, notably in the region of a neck of the latter.

10. The receptacle as claimed in claim 7, wherein the complementary attachment part comprises at least one magnet, preferably a plurality of magnets, for example three, distributed independently and preferably regularly about the complementary attachment part, notably at 120°.

11. A system for dispensing a determined quantity of a cosmetic product into a receptacle from a reservoir, said system comprising a machine as claimed in claim 1 and at least one receptacle comprising a body defining an interior space for reception of the cosmetic product and of which a free edge delimits an opening located opposite a bottom, the receptacle comprising a complementary attachment part of the attachment member of the machine.
